(19) United States
(12) Patent Application Publication
(10) Pub. No.: US 2015/0163987 A1
(43) Pub. Date: Jun. 18, 2015

(54) Reciprocating Gardening Tool and Gardening Tool Attachment for Reciprocating Power Tool

(71) Applicant: G.H.L. International, Inc., Cedaburg, WI (US)

(72) Inventor: John M. Lipscomb, Cedarburg, WI (US)

(21) Appl. No.: 14/576,194

(22) Filed: Dec. 18, 2014

Related U.S. Application Data
(60) Provisional application No. 61/917,569, filed on Dec. 18, 2013.

(51) Int. Cl. A01B 1/06; A01B 1/16

(52) U.S. Cl. CPC A01B 1/065; A01B 1/16

(57) ABSTRACT

A hand held gardening tool has a drive with a reciprocating head to which a removable garden tool attachment formed of an elongate plate that can be a reciprocating saw blade formed into a J-shape, U-shape or O-shape has a non-straight and non-smooth ground engaging surface that preferably is a toothed or serrated elongate edge facing a user of the tool during ground engagement when pulled or dragged by the user toward the user during use. The drive reciprocates the attachment when the ground engaging surface engages the ground breaking up the ground cultivating the ground. A preferred tool is a reciprocating saw. The tool can include an extendable weeder guide extendable that is adjustable along a plurality of degrees of freedom. The weeder guide can have a foot that rides on the ground helping the user to more easily and steadily break up the ground with the reciprocating attachment.

### CROSS-REFERENCE

Pursuant to 35 U.S.C. §119(e), this application claims all benefits to and priority in U.S. Provisional Application Ser. No. 61/917,569, filed on Dec. 18, 2013, the entirety of which is hereby expressly incorporated by reference herein.

### FIELD

The present invention is directed to a garden tool and garden tool attachment for a power tool and more particularly to such a garden tool capable of weeding, cultivating, loosening soil and the like that can be configured for attachment to a reciprocating power tool, e.g., reciprocating saw, of hand-held construction.

### BACKGROUND

Many attempts have been made in the past to help gardeners weed, break up soil, aerate soil and cultivate. While many have been successful, improvements nonetheless remain desirable.

What is needed is an attachment for a hand-held power tool that enables the power-tool user to weed, break up soil, aerate soil and/or cultivate soil.

### SUMMARY

The present invention is directed to a gardening tool and ground cultivating gardening tool attachment for such a tool that is formed of an elongate plate that can be a reciprocating saw blade or reciprocating saw blade blank. The gardening tool attachment is generally flat, thin and has an elongate stem with one end of the stem formed with a mounting tang and a portion distal the mounting tang formed into a J-shaped or oval-shaped weeder head. The mounting tang preferably is a conventional reciprocating saw blade mounting tang for enabling secure and easy attachment to a blade mount of a reciprocating tool head of the gardening tool. The weeder head has a non-smooth ground engaging surface that preferably is an outer edge of the stem of the attachment that faces generally toward a user of the tool when pulling or dragging the engaging surface through or along the ground while being reciprocated by a drive of the gardening tool. In a preferred embodiment, the ground engaging edge is serrated and/or formed with at least a plurality of pairs of teeth. The ground engaging surface is part of a ground breaker section of the weeder head that extends between and can extend along a pair of spaced apart and generally parallel trenching guides that extend upwardly out of the ground during gardening tool attachment reciprocation. The spaced apart trenching guides help more stably and smoothly guide movement of the attachment while submerged underground while also providing visual feedback to the user of the exact location where weeding, cultivation, etc. is occurring.

A preferred gardening tool is formed of a reciprocating power tool that preferably is a reciprocating saw with the blade removed and a gardening tool attachment mounted in place of the blade. In a preferred embodiment, one or more gardening tool attachments is formed of a reciprocating saw blade or saw blade blank three dimensionally formed into a J-shape or oval loop shape having a generally U-shaped weeder head formed by the trenching guides and the ground breaker section between the guides.

A weeder guide can be mounted to part of the housing of the tool, such as alongside the reciprocating tool head, to provide a guide having a foot which a user can slidably support the tool on the ground during operation. Such a weeder guide can be length adjustable, pivotable, and/or angularly adjustable along a plurality of degrees of freedom to help facilitate movement over uneven terrain of the gardening tool attachment in engagement with the ground toward the user during use and operation.

### DRAWING DESCRIPTION

One or more preferred exemplary embodiments of the invention are illustrated in the accompanying drawings in which like reference numerals represent like parts throughout and in which:

FIG. 1 is an isometric view of a reciprocating power tool including a gardening tool attachment according to one embodiment of the present invention;

FIG. 2 is a side view of the reciprocating power tool of FIG. 1 including the gardening tool attachment of FIG. 1;

FIG. 3 is a top view of second preferred gardening tool attachment; and

FIG. 4 is a top view of third preferred gardening tool attachment.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

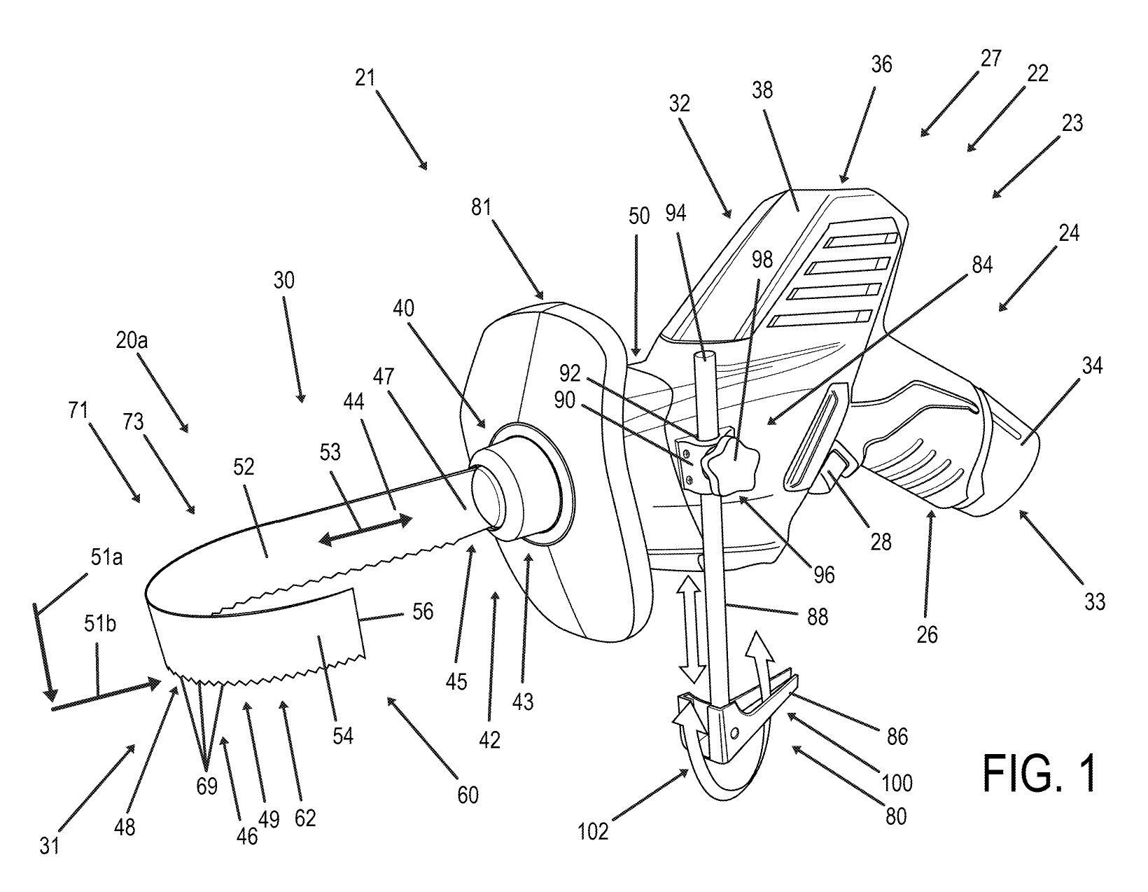

FIGS. 1-4 illustrate preferred embodiments of gardening tool attachments 20a, 20b, and 20c of a gardening tool 21 constructed in accordance with the present invention that includes a powered drive 22 that preferably is of hand-held construction having a handle 24 with a hand grip 26 that includes a forwardly facing manually operable trigger or switch 28 (FIG. 1) that is manually depressed by a user manually grasping the handle 24 to actuate and power the drive 22 and reciprocate the gardening tool attachment 20a, 20b and/or 20c attached to the tool 21. When the trigger 28 is actuated, the gardening tool drive 22 relatively rapidly moves the gardening tool attachment 20a, 20b or 20c in a back and forth motion relative to the drive 22 thereby oscillating the attachment 20a, 20b or 20c at a rate of at least once per second and preferably at a rate of at least a plurality of times per second while the attachment 20a, 20b or 20c is engaged with the ground thereby weeding, loosening soil, aerating soil, and/or cultivating the ground.

As is discussed in more detail below, a preferred garden tool attachment 20a, 20b, and 20c constructed in accordance with the present invention has an elongate ground-engaging tool body 30 with a ground-engaging head 31 especially configured for use in gardening activities including weeding, cultivating and/or loosening soil, which ordinarily tend to be quite laborious when done manually. As is also discussed in more detail below, a preferred gardening tool 21 includes an adjustable gardening tool guide or weeder guide 90 that is extendible outwardly from the tool 21 adjacent the gardening tool attachment 20a, 20b or 20c to engage the ground during use and operation to enable a user of the gardening tool 21 to more stably guide the gardening tool attachment 20a, 20b and 20c through the ground.

A preferred gardening tool drive 22 is provided by a hand-held reciprocating power tool 32, which can be electrically powered via a power cord and/or using an on-board power source 33 that can be a rechargeable battery 34 that can be received in and/or form part of the drive handle 24. Where the drive 22 is equipped with such a rechargeable battery 34, the battery 34 can be a lithium ion battery, a nickel metal hydride battery, a nickel cadmium battery, a lead acid battery, or another suitable type of rechargeable battery. Where equipped with such a battery 34, the battery 34 can be removably attached, such as by being removably plugged into a socket formed in the powered drive 22, such as a socket formed in part of the handle 24 of the drive 22, such as depicted in FIG. 1. If desired, the on-board power source 33 can be or otherwise include a fuel cell, such as a hydrogen powered fuel cell, a solar cell, or the like. If desired, the powered drive 22 of another preferred embodiment of a gardening tool 21 constructed in accordance with the present invention can have a powered drive 22 in the form of a combustible-fuel powered drive that can be an internal combustion engine, gas turbine, or the like, which operates on gasoline, propane, butane, methane, diesel, kerosene or another combustible fuel.

The gardening tool drive 22 has a drive body 36 that includes handle 24, configured with a hand grip 26 that can be of a pistol grip configuration for manual grasping by an operator of the gardening tool 21, a drive housing 38, e.g., motor housing 38, which can enclose or house a prime mover (not shown), such as an electric motor and/or geartrain, and a gardening tool attachment-receiving reciprocating head 40 extending from a tool head guiding collar 50. Although not shown in FIG. 1, the reciprocating tool head guiding collar 50 can be elongate and configured as a second hand grip that can be grasped by the user when using the tool 21. The tool-mounting head 40 preferably is configured with a gardening tool attachment holder 42 for releasable mounting of the gardening tool attachment 20a, 20b and/or 20c therein. When the gardening tool attachment 20a, 20b, and/or 20c is mounted in the holder 42, the attachment 20a, 20b and/or 20c preferably is fixed to the holder 42 such that the attachment 20a, 20b, or 20c and holder 42 reciprocate substantially in unison during operation of the drive 22.

The holder 42 is configured for releasable mounting of gardening tool attachments 20a, 20b and 20c enabling replacement of the attachment when worn, spent or unusable. In a preferred embodiment, the holder 42 is configured for releasable attachment of a plurality of differently configured gardening tool attachments 20a, 20b and/or 20c enabling interchangeability of at least a plurality of different types of gardening tool attachments 20a, 20b or 20c depending on the type of cultivating, weeding, soil aeration, soil loosening or other gardening application needed or desired by the gardening tool user. In a preferred embodiment, gardening tool attachment 20a is configured for a first gardening application, attachment 20b is configured for a second gardening application, and attachment 20c is configured for a third gardening application.

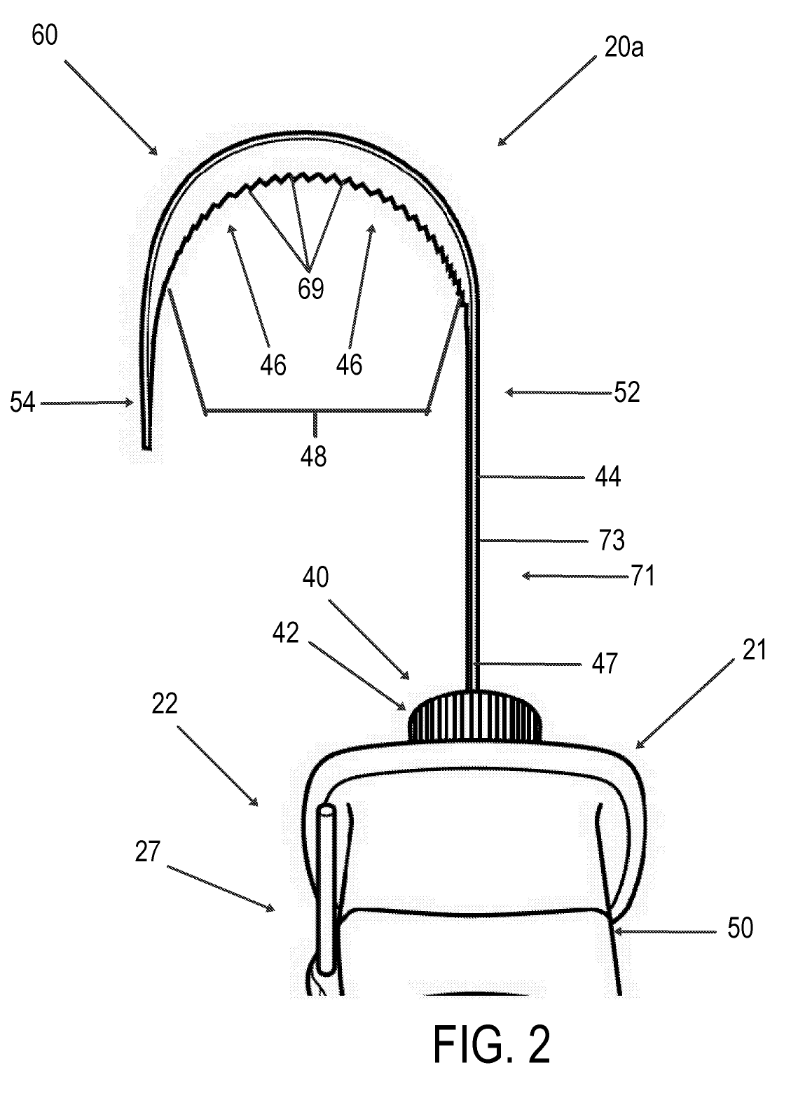

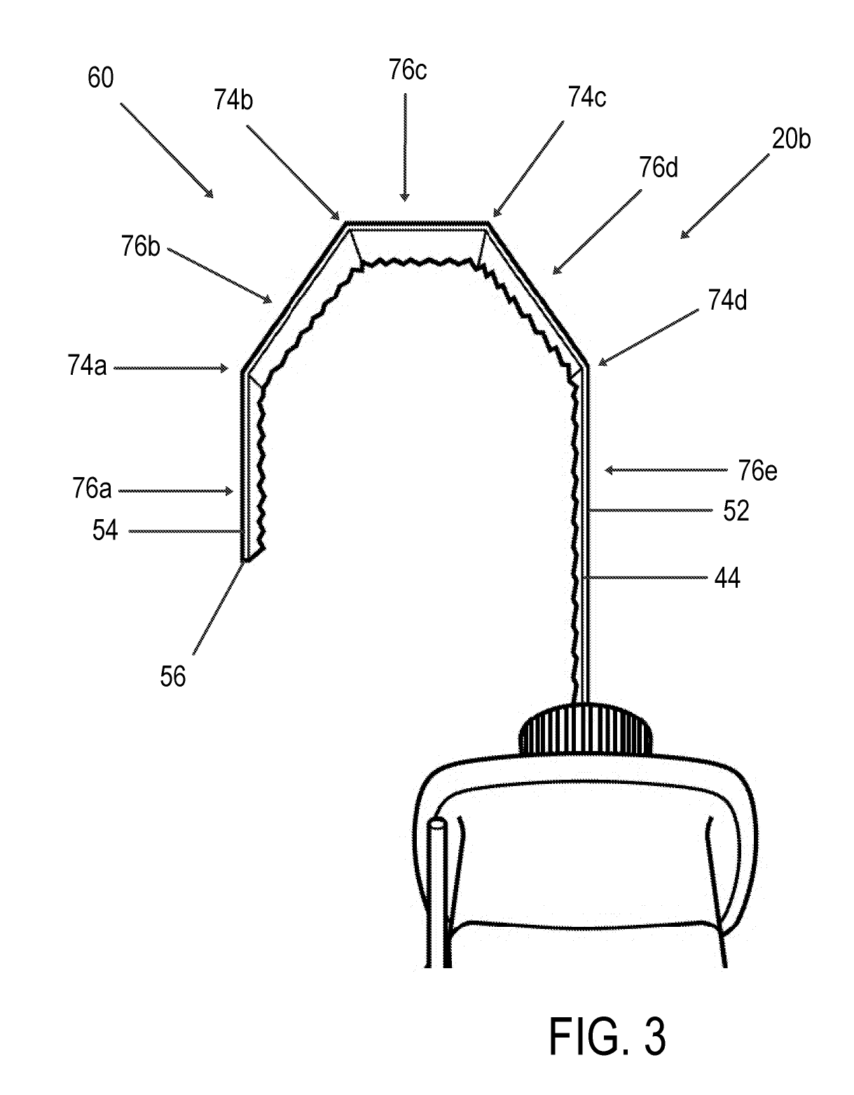

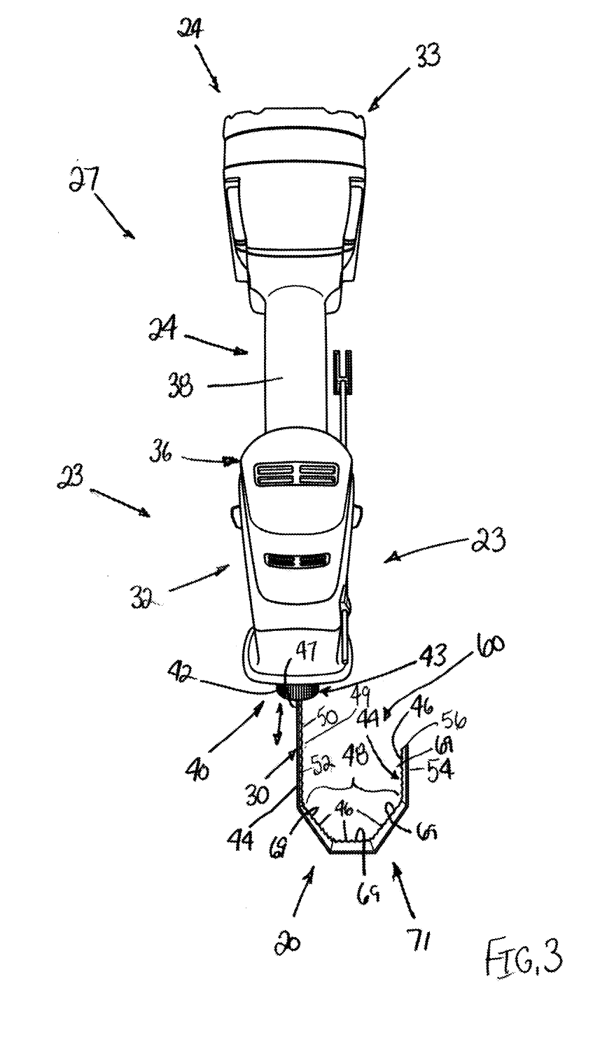

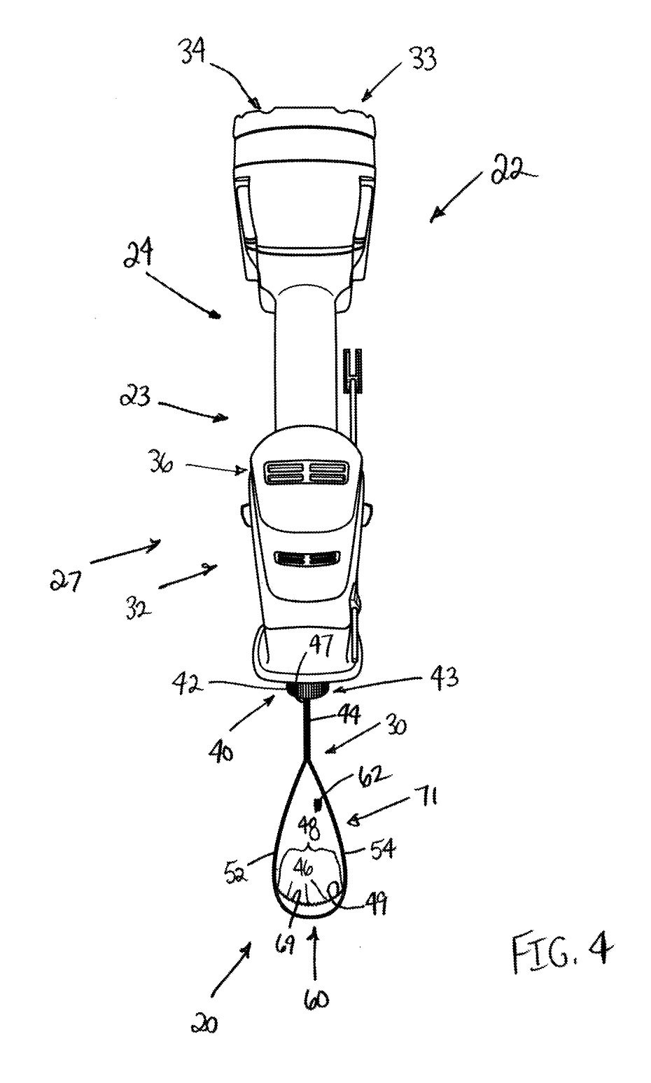

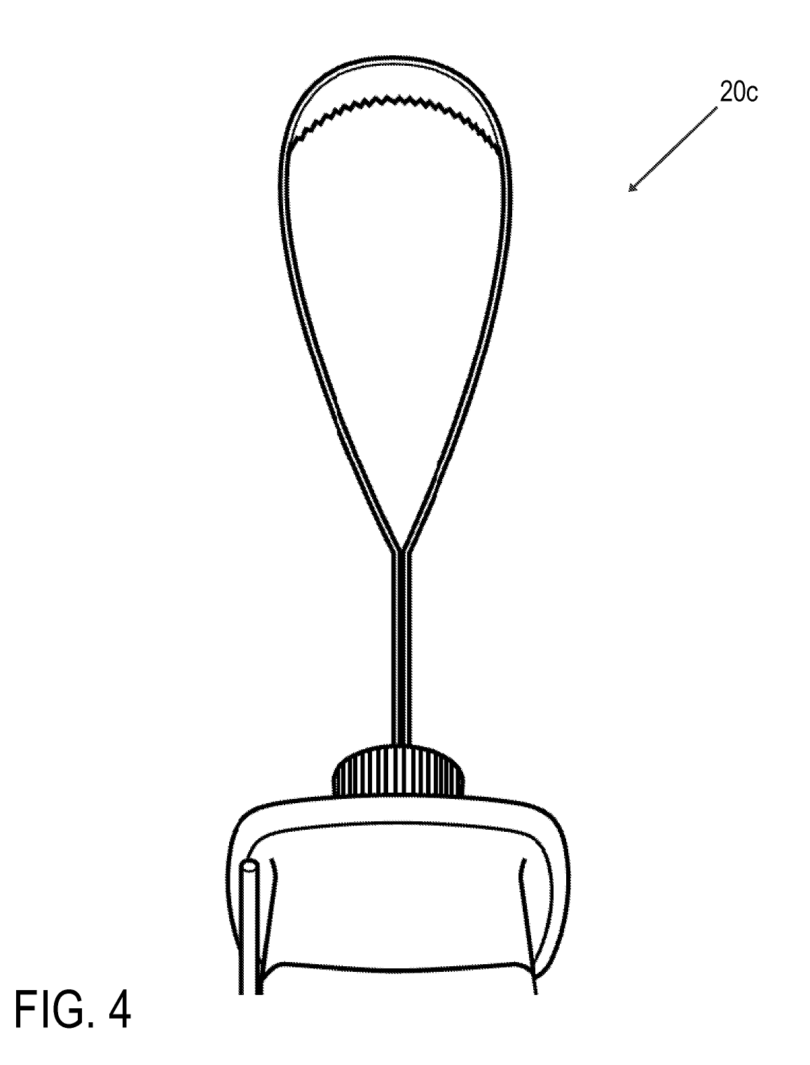

In this regard, gardening tool attachment 20a shown in FIGS. 1 and 2 is configured for weeding around plants, trees and the like in dirt or looser soil because of its three-dimensional J-shaped curvilinear construction providing a user better maneuverability of the attachment 20a being reciprocated while engaged with and in the ground. The gardening tool attachment 20b shown in FIG. 3 is configured for weeding around plants, trees and the like where the ground is harder, has a considerable amount of clay, has larger roots, and/or larger rocks because its J-shaped configuration is formed with a plurality of straight segments increasing the stiffness and flexural rigidity of the attachment 20b. The gardening tool attachment 20c shown in FIG. 4 is configured for reaching deeper depths in the ground during use with its three dimensional oval or loop-shape enabling a user to penetrate the ground deeper during reciprocation of the attachment 20c.

In a preferred embodiment, a gardening tool 21 constructed in accordance with the present invention is of convertible construction being convertible between a gardening tool 21 and another type of a tool, such as a reciprocable power tool that preferably is a reciprocating saw. In such a preferred gardening tool embodiment, the gardening tool 21 has a holder 42 configured for releasable mounting of at least one of a plurality of different types of reciprocating power tool attachments in addition to being configured for releasable mounting of at least one of at least a plurality of different types of gardening tool attachments 20a, 20b and 20c. While such a holder 42 can include or be in the form of a chuck, an adapter, a clamp, and/or a socket configured to removably receive and fixedly hold such an attachment as is known in the art, a preferred embodiment of a gardening tool 21 constructed in accordance with the present invention has a holder 42 configured for receiving and fixedly holding a plurality of differently shaped or configured gardening tool attachments 20a, 20b and/or 20c having a tool attachment end configured the same as the end of a conventional reciprocating saw blade.

In a preferred gardening tool embodiment where the drive 22 is configured with a holder 42 configured to enable releasable gardening tool attachment mounting, the holder 42 preferably is a reciprocating saw blade holder 43 configured for receipt and fixturing of a mounting end of a conventional reciprocating saw blade to the reciprocable head 40 of the tool 21. In one such preferred embodiment, the gardening tool 21 is formed of a reciprocating power tool that preferably is a conventional reciprocating saw 27 having a holder 42 that is a conventional reciprocating power tool attachment holder 43 configured to receive and releasably retain at least a plurality of the following different types of reciprocating power tool attachments: metal and/or wood cutting blades, e.g., reciprocating saw blades (such as SAWZALL blades), brushes, e.g., wire and plastic bristle brushes, scrapers, pads, e.g., cleaning pads, files, and the like that are releasably mounted in the holder 42. Such a reciprocating power tool attachment holder 43 preferably is configured to releasably receive and retain a universal mounting tang of a reciprocating saw blade and/or other type of reciprocating power tool or attachment.

Tang of gardening tool attachments 20a, 20b and/or 20c preferably is a conventional reciprocating saw blade mounting tang such as same or similar to that disclosed and shown in U.S. Pat. No. 5,575,071; U.S. Pat. No. 5,903,983; U.S. Pat. No. 6,237,231; and U.S. Pat. No. 7,600,458 the disclosures of each of which are expressly incorporated by reference in their entirety. Gardening tool attachment holder 42 preferably is a conventional reciprocating saw blade holder 43 like one or more of those disclosed and shown in U.S. Pat. No. 5,575,071; U.S. Pat. No. 5,903,983; U.S. Pat. No. 6,237,231; and U.S. Pat. No. 7,600,458 the disclosures of each of which are expressly incorporated by reference in their entirety.

In one preferred embodiment, the hand-held gardening tool drive 22 is a conventional hand-held reciprocating power tool 23 that can be a reciprocating saw, e.g., SAWZALL, a HACKZALL, a sabre saw, a saber saw, or another type of commercially available reciprocating power tool that relatively rapidly reciprocates the garden tool attachment 20a, 20b or 20c in a push-pull reciprocating motion during engagement of the ground with the garden tool attachment 20. In a preferred embodiment, the drive 22 reciprocates the garden tool attachment 20a, 20b, and/or 20c at a rate of at least a plurality of times per second and preferably at a rate of between two times per second and 100 times per second. In one preferred embodiment, the drive 22 is a conventional reciprocating power tool 23 that preferably is a reciprocating saw 27 that reciprocates the garden tool attachment 20a, 20c, and/or 20c at a rate of between 10 times per second and 50 times per second that preferably is user-selectable or user-regulated enabling the garden tool attachment 20 to more effectively engage and break up the ground during use and operation as a result of being so rapidly reciprocated.

FIGS. 1 and 2 illustrate a first preferred embodiment of a gardening tool attachment 20a constructed in accordance with the present invention that is configured for releasable attachment to a reciprocable head 40 of a reciprocating drive 22 of a gardening tool 21 that preferably is a reciprocating power tool 23, such as the conventional reciprocating saw 27 shown in the drawings. The first gardening tool attachment 20a is generally J-shaped having an elongate gardening tool attachment body 30 with an elongate base or stem 44 configured for being releasably mounted at or adjacent one end 45 in the holder 42 of the head 40 of the drive 22. The gardening tool attachment 20a has a non-straight or non-smooth ground-engaging surface 46 extending longitudinally along at least a ground breaker section 48 of the body 30 of the attachment 20a that is of non-straight and/or non-smooth construction to facilitate engagement with the ground, e.g., soil, sand, clay, and/or dirt, in a manner that digs into the ground and/or breaks up the ground when the reciprocating attachment 20a makes initial contact therewith. The mounting end 45 of the stem 44 of the gardening tool attachment 20a formed with a conventional reciprocating saw blade mounting tang 47 that enables the attachment 20a to be releasably mounted in a holder 42 configured for releasable receipt and retention of thereof. The mounting tang 47 of at least gardening tool attachment 20a preferably is a conventional reciprocating saw blade mounting tang like those disclosed and shown in U.S. Pat. No. 5,575,071; U.S. Pat. No. 5,903,983; U.S. Pat. No. 6,237,231; and U.S. Pat. No. 7,600,458 the disclosures of each of which are expressly incorporated by reference in their entirety.

The ground-engaging surface 46 of the gardening tool attachment 20a preferably is elongate and extends along at least a portion of an outer edge 49 of the garden tool attachment 22 that faces generally downwardly and generally toward a user grasping the handle 24 of the drive 22 who is pulling the attachment 20a generally downwardly and generally toward the user in the direction of arrows 51a and 51b shown in FIG. 1 during use and operation. This is done while the attachment 20a is reciprocating back and forth in the direction of bidirectional arrow 53 when the ground-engaging surface 46 of the attachment 20 is in engagement with the ground during use and operation. The ground-engaging edge 46 extends along a portion of the user-facing outer edge 49, extends along the ground-breaker section 48 of the attachment 20a, and can extend substantially the length of the body 30 of the attachment 20a, such as is illustrated in FIGS. 1 and 2. In a preferred embodiment, the ground engaging edge 46 is a shorter portion of the outer edge 49 of the attachment 20a that generally faces toward the user when the ground-engaging surface 46 is engaged with the ground with the tool 21 being pulled by the user toward the user.

The ground-breaker section 48 is offset from the stem 44, such as by preferably being generally transversely offset relative to the longitudinal or lengthwise extent of the stem 44. As is shown in FIGS. 1 and 2, the ground breaker section 48 extends generally transversely relative to the bidirectional direction 53 of gardening tool attachment reciprocation between a pair of spaced apart generally parallel trenching or ground engagement guides 52 and 54 that extend on either side thereof. Each trenching or ground engagement guides 52 and 54 is integrally formed of part of the gardening tool attachment body 30 with one of the guides 52 integrally formed of the part of the body 30 that includes the stem 42 and is located adjacent one side of the ground breaker section 48 and the other one of the guides 54 integrally formed of another part of the body 30 located adjacent the other side of the ground breaker section 48. In the preferred gardening tool attachment 20a shown in FIGS. 1 and 2, the other guide 54 extends to or adjacent a free end 56 of the attachment 20a. In a preferred gardening tool attachment embodiment, the ground engagement edge 46 of the attachment 20a extends along the ground breaker section 48 of the attachment 20a and along at least a portion of each one of the trenching or ground engagement guides 52 and 54. In one such preferred embodiment, the ground engagement edge 46 extends along the ground breaker section 48 of the attachment 20a and along both guides 52 and 54.

In each one of the preferred garden tool attachments 20a, 20b and 20c of the present invention shown in the drawings, one of the trenching guides 52 is integrally formed of a portion of the body 30 that includes the stem 42 and is located adjacent one side or one end of the ground-breaker section 48 and the other one of the trenching guides 54 is integrally formed of another portion of the body 30 located adjacent the other side or other end of the ground-breaker section 48. Where the garden tool attachment 20a and/or 20b is generally J-shaped, such as depicted in FIGS. 1-3, trenching guide 54 is formed of part of the gardening tool attachment body 30 located adjacent to and/or include the free end 56 of the attachment 20a and/or 20b shown in FIGS. 1-3.

The pair of trenching guides 52 and 54 are preferably generally parallel for stably guiding movement of the garden tool attachment 20a, 20b and/or 20c when at least a portion of its ground-breaker section 48 is at least partially submerged in soil, dirt, turf, sand, and/or clay of the ground while being reciprocated by the drive 22 during use and operation. With specific reference to FIG. 1, the pair of trenching guides 52 and 54 are generally parallel to help stably guide movement of the garden tool attachment 20a during weeding or cultivating while at least the portion of the ground engaging edge 49 therebetween is submerged in the ground by preventing the attachment from twisting, turning or otherwise deviating from a direction of motion generally downwardly (arrow 51a) and toward the user (arrow 51b). In doing so, the trenching guides 52 and 54 help guide gardening tool attachment movement in substantially a straight line toward the user while at least a portion of the ground engaging edge 49 extending between the guides 52 and 54 is submerged under the ground. During weeding or cultivating operation, at least a portion of each trenching guide 52 and 54 is submerged in the ground and sticks upwardly from or out of the ground on either side of the ground-breaker section 48 so as to be visually apparent or viewable by the user thereby advantageously providing visual feedback or visual guidance in real time of the path of travel of the ground-breaker section 48 during gardening tool use and operation.

The trenching guides 52 and 54, along with the ground-breaker section 48 extending between the trenching guides 52 and 54, define a generally U-shaped weeder head 60 that travels through soil, dirt, sand, clay and/or the like as the gardening tool attachment 20a, 20b, and/or 20c is being oscillated back and forth by the drive 22 of the gardening tool 21. As the attachment 20a, 20b and/or 20c is being oscillated back and forth while submerged under soil, dirt, sand and/or clay of the ground during gardening tool use and operation, soil, dirt, sand, clay and/or the like loosened by the attachment 20a, 20b and/or 20c is rapidly oscillated and/or agitated at about the same speed or rate as the reciprocation speed of the attachment 20a, 20b and/or 20c. As is shown best in FIGS. 2 and 3, the ground-breaker section 48 is oriented generally perpendicularly relative to the reciprocating head 40 of the drive 22 with the generally U-shaped weeder head 60 having a mouth 62 through which soil, dirt, sand, clay and the like of the ground enters the head 60, is engaged by the ground-engaging surface 46 of at least the ground-breaker section 48, and is rapidly vibrated, agitated and/or oscillated by the rapidly reciprocating ground-breaker section 48 engaging the ground, which loosens the soil, dirt, sand, clay and the like aerating the ground, loosening weeds in the ground, and/or otherwise cultivating the soil in a manner that requires relatively low effort on the part of the user.

The ground-engaging surface 46, e.g., edge, of the attachment 20a extends along at least a portion of the ground-breaker section 48 and can also extend along a portion of each trenching guide 52 and 54 if desired. In the preferred embodiments of the garden tool attachments 20 shown in FIGS. 1-4, the ground-engaging surface 46 of the attachment 20 extends along substantially the entire length of the ground-breaker section 48, preferably extending along the user-facing outer edge 49 of the ground-breaker section 48, and a ground-engaging surface 46 preferably also extends along at least portion of the user-facing outer edge 49 of each trenching guide 52 and 54 adjacent the ground-breaker section 48. While the ground-engaging surface 46 can extend substantially continuously uninterrupted as depicted in FIGS. 1-4, the ground-engaging surface 46 can be interrupted and/or discontinuous if desired having spaced apart regions or sections of ground-engaging surface 46 formed in the user-facing outer edge 49 extending along the ground-breaker section 48 and/or at least a portion of each trenching guide 52 and 54.

In the preferred embodiments of the gardening tool attachments 20a, 20b and/or 20c shown in FIGS. 1-4, the ground-engaging surface 46 is of non-straight construction to provide a rough, jagged and/or penetrating ground-engaging surface 46 that more easily penetrates the ground and breaks up the ground during weeder or cultivator operation. In a preferred construction of the ground-engaging surface 46, the ground-engaging surface 46 includes at least a plurality of pairs, i.e., at least three, of teeth 69 that preferably are generally V-shaped saw-blade teeth. If desired, ground-engaging surface 46 can be formed of and/or otherwise include a serrated surface (not shown) like that found on the knife edge of a serrated knife or the like. If desired, ground-engaging surface 46 can be formed of and/or otherwise include a plurality of pairs, i.e., at least three, of elongate outwardly extending and spaced apart tines (not shown) or barbs. If desired, ground-engaging surface 46 can be formed of a combination of teeth 69, serrations, tines and/or barbs with one or more teeth, serrations, tines and/or barbs angled upwardly and downwardly relative to body 30, edge 49 and/or arrow. Although a ground-engaging surface 46 is shown only on one side or edge of the garden tool attachments 20a, 20b and/or 20c shown in the drawing figures, a ground-engaging surface 46 can be formed in both sides or edges of the attachment 20a, 20b, and/or 20c if desired, such as where an attachment 20a, 20b and/or 20c of reversible construction is desired.

The gardening tool attachment 20a shown in FIGS. 1 and 2 has a generally curved ground-breaker section 48 with each trenching guide 52 and 54 also at least partially curved. The ground-engaging surface 46 is formed of saw blade teeth 69 that extend along substantially the entire length of the attachment 20a from adjacent the mounting end 47, along the stem 44, along one trenching guide 52, along the ground-breaker section 48, as well as along the other trenching guide 54 to the free end 56 of the attachment. 20a. In a preferred embodiment, a garden tool attachment 20a constructed in accordance with the present invention illustrated in FIGS. 1 and 2 is formed of or from a conventional commercially available reciprocating saw blade 71 that is formed by bending, roll forming, spinning, stretch forming, or by using another metal forming process, e.g., sheet metal forming process, into the generally J-shaped attachment 20a shown in FIGS. 1 and 2.

The use of such a readily commercially available reciprocating saw blade 71 as a blank 73 from the generally J-shaped garden tool attachment 20a shown in FIGS. 1 and 2 is formed is advantageous because it produces a tough, resilient and durable attachment 20 having saw teeth 69 already integrally formed along at least one edge that produces a ground-engaging surface 46 that efficiently engages, breaks up, loosens, agitates, vibrates, weeds and/or cultivates ground during use and operation. As a result of using commercially available reciprocating saw blades as blanks formed into garden tool attachments 20a, a relatively economical disposable attachment 20a is produced that can be used with at least a plurality of different types of commercially available hand-held reciprocating tools, including one or more commercially available hand-held reciprocating saws. If desired, a blank for making a reciprocating saw blade 71 can also be used as a blank 73 from which garden tool attachment 20a is made. The same is true for the gardening tool attachment 20b shown in FIG. 3.

The gardening tool attachment 20b shown in FIG. 3 also is generally J-shaped like attachment 20a but has a plurality of pairs of spaced apart bends 74a, 74b, 74c, and 74d forming substantially straight planar segments 76a, 76b, 76c, 76d and 76e arranged in a J-shape with the ground-breaker section 48 formed of a plurality of pairs of the segments 76b, 76c and 76d with a middle or bottom one of the segments 76c being generally perpendicular to the stem 44 of the attachment 20b and each outwardly extending segment 76b and 76d being outwardly angled at an included angle of between 25° and 75° relative to the middle or bottom segment 76c. The trenching guides 52 and 54 are respectively formed of a pair of oppositely extending segments that can be generally parallel as shown in FIG. 3.

The garden tool attachment 20c shown in FIG. 4 is loop-shaped having an enclosed weeder head 60 that can be generally circular or generally oval with the ground-breaker section 48 being curved and curvilinearly transitioning into a trenching guide 52 and 54 that form opposite sides of the enclosed weeder head 60. Each trenching guide 52 and 54 converges at or adjacent the stem of the attachment and can be joined together such as by banding, riveting, fastening, adhesively bonding, welding, or the like.

One or more reciprocating saw blades 71 suitable for use as blanks 73 that can be formed into a garden tool attachment 20a, 20b and/or 20c constructed in accordance with the present invention include (a) a MILWAUKEE model no. 49-00-5410 reciprocating saw blade that is generally planar and made of metal or of metallic construction, e.g., bi-metallic construction, having a length of between 2 inches and 5 inches (preferably about 4 inches), a thickness of no more than one-quarter inch (preferably no more than about one-eighth of an inch), a width of between one-half inch and two and a half inches (preferably about one inch and no more than two inches), and at least one toothed edge with at least 25 teeth spaced apart along the toothed edge (preferably having about 50 teeth and a teeth density of about 12 teeth per inch); (b) a MILWAUKEE model no. 48-00-5701 reciprocating saw blade that is generally planar and made of metal or of metallic construction, e.g., bi-metallic construction, having a length of between 5 inches and 7 inches (preferably about 6 inches), a thickness of no more than one-quarter inch (preferably no more than about one-eighth of an inch), a width of between one-half inch and two and a half inches (preferably about one inch and no more than two inches), and at least one toothed edge with at least 20 teeth spaced apart along the toothed edge (preferably having about 48 teeth and a teeth density of about 8 teeth per inch); (c) a MILWAUKEE model no. 48-00-1305 12 inch by 4/5 pruning reciprocating saw blade that is generally planar and made of metal or of metallic construction, e.g., bi-metallic construction, having a length of between 10 inches and 14 inches (preferably about 12 inches), a thickness of no more than one-quarter inch (preferably no more than about one-eighth of an inch), a width of between one-half inch and three and a half inches (preferably about one inch and no more than three inches), and at least one toothed edge with at least 10 teeth arranged in a staggered tooth pattern having different lengths and depths that are spaced apart along the toothed edge (preferably having about 14 teeth and a teeth density of about 5 teeth per inch); (d) a MILWAUKEE model no. 48-00-5037 reciprocating saw blade that is generally planar and made of metal or of metallic construction, e.g., bi-metallic construction, having a length of between 8 inches and 16 inches (preferably about 12 inches), a thickness of no more than one-quarter inch (preferably no more than about one-eighth of an inch), a width of between one-half inch and two and a half inches (preferably about one-half inch and no more than one inch), and at least one toothed edge with at least 50 teeth spaced apart along the toothed edge (preferably having about 60 teeth and a teeth density of about 5 teeth per inch), (e) a MILWAUKEE model no. 48-00-5306 reciprocating saw blade that is generally planar and made of metal or of metallic construction, e.g., bi-metallic construction, having a length of between 6 inches and 10 inches (preferably about 9 inches), a thickness of no more than one-quarter inch (preferably no more than about one-eighth of an inch), a width of between one-half inch and two and a half inches (preferably about one-half inch and no more than two inches), and at least one toothed edge with at least 40 teeth spaced apart along the toothed edge (preferably having about 45 teeth and a teeth density of about 5 teeth per inch), (f) a MILWAUKEE model no. 48-00-48107 reciprocating saw blade that is generally planar and made of metal or of metallic construction, e.g., bi-metallic construction, having a length of between 4 inches and 8 inches (preferably about 6 inches), a thickness of no more than one-quarter inch (preferably no more than about one-eighth of an inch), a width of between one-half inch and three and a half inches (preferably about two inches and no more than two and a half inches), and at least one toothed edge with at least 10 teeth spaced apart along the toothed edge (preferably having about 14 teeth and a teeth density of about 14 teeth per inch), and/or any other commercially available reciprocating saw blade made of metal or metallic construction, e.g. bi-metallic construction, having a length of between four inches and eighteen inches, a thickness of no more than about one-quarter inch, a width of between one-half inch and three and a half inches, at least 10 teeth and a tooth density of at least two teeth per inch along with a reciprocating saw blade mounting tang such as a universal one-half inch mounting tang well known in the industry. Where such a commercially available reciprocating saw blade blank 73 is used to form the embodiment of the garden tool attachment 20c shown in FIG. 4, a further joining step must be performed to adjoin one of the trenching guides 54 to either the other one of the trenching guide 52 and/or the stem 44.

The present invention also contemplates a hand held gardening tool 21 in accordance with the present invention where the drive 22 and method of weeding or cultivating using such a drive 22 where the drive 22 is an off-the-shelf commercially available reciprocating saw 27 that can be a MILWAUKEE HACKZALL cordless reciprocating saw, e.g., model no. 2420-01, or another type of commercially available cordless and/or compact reciprocating saw. In a method of using a commercially available reciprocating saw, a garden tool attachment, such as an attachment 20a, 20b and/or 20c constructed in accordance with that shown in FIGS. 1-4, is removably mounted to the tool holder 40 of the drive 22. Where the attachment 20a, 20b and/or 20c is equipped with a mounting tang 47, such as a one-half inch universal mounting tang (not shown), the attachment 20a, 20b and/or 20c is removably mounted to a reciprocating saw 27 having a tang receiving tool holder 42.

Once the attachment 20a, 20b and/or 20c is mounted to the drive 22, the handle 24 of the drive 22 is grasped by a user and the drive 22 maneuvered to bring the weeding head 60 of the attachment 20a, 20b and/or 20c toward and into contact with the ground. In a preferred embodiment, the handle 24 of the gardening tool 21 is connected to the drive 22 and disposed adjacent the drive 22 such that a user using the hand held gardening tool 21 must bend over or kneel down onto the ground during use and operation in cultivating, weeding or otherwise using the tool 21 to engage the ground. Preferably before contacting the ground, the switch or trigger 28 of the tool 22 is squeezed by the user to reciprocate the attachment 20a, 20b and/or 20c at reciprocating speeds in accordance with that discussed above. As the weeding head 60 contacts the ground, the ground-engaging surface 46 of at least the ground-breaker section 48 engage the ground enabling at least part of the ground-breaker section 48 to become submerged under the surface of the ground as the reciprocating action of the attachment 20a, 20b and/or 20c loosens, digs up, agitates, vibrates, aerates, weeds and/or cultivates ground engaged by the teeth 69 of the ground engaging surface 46.

The user manipulates the tool 21 to move the weeding head 60 of the attachment 20a, 20b and/or 20c relative to the ground toward the user in a raking action during weeding and/or cultivation operation. In a preferred method of operation where the ground engaging surface 46 faces toward the user when grasping the handle grip 26 of the tool 21, the tool 21 is manipulated to pull the weeding head 60 and hence the engaged and/or submerged ground-breaker section 48 through the ground toward the user in the direction of arrow 51b as depicted in FIG. 1. As the user moves the tool 21 thereby substantially simultaneously moving the weeding head 60 relative to the ground during weeding and/or cultivating, the trench guides 52 and 54 of the attachment 20a, 20b and/or 20c help guide movement of the head 60 generally in or along a straight line toward the user.

When the ground-engaging surface 46 or any other part of the attachment 20a, 20b and/or 20c become too worn or are no longer suitable for use, the user simply removes the spent or used attachment 20a, 20b and/or 20c from the holder 40 of the tool 22 and puts in a new attachment 20a, 20b and/or 20c. In another aspect of the method, one type of attachment 20a that is configured for weeding soil or dirt can be removed from the holder 40 of the tool 22 by the user and replaced by another type of attachment 20c that is configured for breaking up clay, aerating soil, cutting roots, and the like.

With reference once again to FIG. 1, the present invention further contemplates a gardening tool 21 constructed in accordance with the present invention having at least one weeder guide 80 that is used to help more stably guide the gardening tool attachment 20a, 20b and/or 20c during engagement with the ground by helping to make it easier to orient the attachment 20a, 20b and/or 20c relative to the ground during use and operation. As is also shown in FIG. 1, such a gardening tool 21 can also include a dirt and debris shield 81 extending outwardly about the periphery of the reciprocating tool head 40 that helps shield a user from any dirt, soil, dust, debris and the like a gardening tool attachment 20a, 20b and/or 20c may kick up during use and operation. Such a dirt and debris shield 81 can be of removable construction if desired.

Weeder guide 80 can be an accessory 82 that can be retrofitted to an existing commercially available reciprocating tool 23 that can be a reciprocating saw 27 by being attached to the tool 23 using fasteners, an adhesive, or another attachment means. Dirt and debris shield 81 can also be an accessory retrofitted to an existing available reciprocating tool 23 that can be a reciprocating saw 27 with the shield 81 attachable in a similar fashion. Where an accessory 82, one or more weeder guides 80 can be sold as part of a kit that includes one or more of the gardening tool attachments 20a, 20b and/or 20c and which can further include a dirt and debris shield 81 that can be purchased by a prospective user to convert a reciprocating power tool 23 they already own, such as a reciprocating saw 27, into a hand held gardening tool 21 constructed in accordance with the present invention. In doing so, the user attaches each weeder guide 80 to a corresponding side of the barrel 50 from which the reciprocating tool head 40 extends and mounts one of the gardening tool attachments 20a, 20b and/or 20c to the tool 23 in the head 40 converting or adapting it from a conventional power tool into a gardening tool 21 constructed in accordance with the present invention.

The weeder guide 80 preferably is angularly adjustable along at least one degree of freedom and can be angularly adjustable along a plurality of degrees of freedom if desired. The weeder guide 80 includes a weeder guide mount 84 for attachment to part of the tool 23, such as part of its drive housing 36 and includes a depth-adjustable and angle-adjustable weeder guide foot 86 that can be extended via an elongate extension 88 in order to make contact with the ground during weeding or cultivating of the ground using a gardening tool attachment 20a, 20b and/or 20c during tool operation. Where a gardening tool 21 in accordance with the present invention has a pair of weeder guides, one of the weeder guides 80 is attached to one side alongside the reciprocating tool head 40 and the other one of the weeder guides is attached to the other side alongside the reciprocating tool head 40. In the preferred weeder guide embodiment shown in FIG. 1, the weeder guide mount 84 preferably is attached to one side of the reciprocating tool head barrel 50 generally in line with the reciprocating tool head 40. As is shown in FIG. 1, the weeder guide mount 84 is fixed to one side of the reciprocating tool head barrel 50 generally in line with a longitudinal axis of the stem 40 of the gardening tool attachment 20a, 20b and/or 20c.

The weeder guide mount 84 has a mounting base 90 with a receptacle 92 that movably or even removably receives the elongate extension 88, such as in the form of an elongate rod 94, whose effective length of extension is controlled by a releasable clamp 96, such as in the form of the rotary clamping knob 98 attached to a threaded stem threaded into the base 90 that is turned to urge the stem against the extension rod 94 to clamp and fix it in place when the desired amount of length or extension has been set. In one preferred embodiment, the weeder guide mount 84 is configured to be able to allow the extension rod 94 to pivot or rotate about an axis of rotation generally perpendicular to the rod 94 that can extend through or be coaxial with the clamping knob 98. Where the weeder guide mount 84 is configured to provide pivoting of the extension rod 94, such a weeder guide mount 84 imparts at least one degree of freedom to the weeder guide 80 that can remain present during gardening tool operation to facilitate guidance of the gardening tool attachment 20a, 20b and/or 20c during ground engagement.

The weeder guide foot 86 can itself be pivotable such as by being pivotally attached to the elongate extension rod 94 enabling the foot 86 to be able to pivotally “float” along the ground enabling the foot 86 to adjust to changes in the three-dimensional contour or surface of the ground as the tool 23 and attachment 20a, 20b and/or 20c are being moved by the user relative to the ground during weeding and/or cultivating. The weeder guide foot 94 can be generally L-shaped having an elongate generally planar-bottomed shoe 100 extending generally parallel to the longitudinal axis or extent of the elongate stem of a gardening tool attachment 20a, 20b and/or 20c attached to the reciprocating head 40 of the tool 21. A leading end 102 of the shoe 100 can be sloped or curved to facilitate sliding movement over and along the ground including while encountering changes in the three dimensional contour of the ground during gardening tool use and operation. Although not shown in FIG. 1, the weeder guide foot 86 can including one or more rollers or wheels that facilitate such movement helping a user to more stably guide the reciprocating gardening tool attachment 20a, 20b and/or 20c during engagement with the ground during tool use and operation.

Where the foot 86 is configured to be pivotable relative to the extension rod 94, the foot 86 can be pivoted against the rod 84 into a storage position where the foot 86 is releasably retained when the gardening tool 21 is not in use. Where the extension rod 94 is pivotably carried by the weeder guide mount 84, the rod 94 can also be pivoted to an out of the way storage position where it is releasably retained in place alongside part of the housing 36 of the tool 21. Such a weeder guide 80 can be conveniently folded against the tool 21 when it is desirable to replace the gardening tool attachment 20a, 20b and/or 20c with a conventional substantially straight reciprocating saw blade (not shown) when it is desired to convert the tool from a hand-held electrically powered reciprocating gardening or cultivating tool 21 of the invention back into a conventional reciprocating power tool 23, namely a reciprocating saw 27, that can then be used as a reciprocating saw by the user.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

It is claimed:

1. A gardening tool attachment for a power tool comprised of an elongate body having (a) a mount configured for removable mounting to a power tool, and (b) a cultivating blade comprised of (i) a ground engaging portion, and (ii) at least one guide that guides movement of the attachment when the ground engaging portion is engaged with the ground and the attachment is being reciprocated.

2. The gardening tool attachment of claim 1, wherein the gardening tool attachment is generally J-shaped and has at least one ground-engaging surface carried by or integrally formed of part of the ground-breaking section that is of non-straight construction.

3. The gardening tool attachment of claim 2 wherein the gardening tool attachment has a pair of guides extending outwardly away from the ground during engagement of the ground by the ground-breaking section that guide movement of the ground-breaking section relative to the ground and wherein the ground-breaking section and pair of spaced apart guides define a generally U-shaped gardening head.

4. The gardening tool attachment of claim 3, wherein each one of the guides have a ground-engaging surface.

5. The gardening tool attachment of claim 3, wherein the ground engaging surface is comprised of a plurality of teeth.

6. The gardening tool attachment of claim 1, wherein the gardening tool attachment is generally loop-shaped and has at least one ground-engaging surface carried by or integrally formed of part of the ground-breaking section that is of non-straight construction.

7. The gardening tool attachment of claim 6, wherein the gardening tool attachment has a pair of guides extending outwardly away from the ground during engagement of the ground by the ground-breaking section that guide movement of the ground-breaking section relative to the ground and wherein the ground-breaking section and pair of spaced apart guides define a generally circular or oval gardening head.

8. The gardening tool attachment of claim 7, wherein each one of the guides have a ground-engaging surface.

9. The gardening tool attachment of claim 8, wherein the ground engaging surface is comprised of a plurality of teeth.

10. The gardening tool attachment of claim 1, wherein the cultivating blade is generally U-shaped having a ground-engaging edge extending along a leading edge of at least a portion of the ground submersible section of the cultivating blade that is configured to break up and/or displace ground in contact therewith during reciprocation of the gardening tool attachment.

11. The gardening tool attachment of claim 10, wherein at least the ground submersible section is curved along its length.

12. The gardening tool attachment of claim 11, wherein the curved ground submersible section is formed of a plurality of generally straight segments having adjacent straight segments interconnected at an angle therebetween.

13. The gardening tool attachment of claim 10, wherein the gardening tool attachment is comprised of an elongate reciprocating saw blade formed into a generally J-shaped gardening tool attachment body having a ground-engaging edge formed of saw blade teeth.

14. The gardening tool attachment of claim 10, wherein the gardening tool attachment is comprised of an elongate reciprocating saw blade formed into a generally oval-shaped or generally O-shaped gardening tool attachment body having a ground-engaging edge formed of saw blade teeth.

15. The gardening tool attachment of claim 10, wherein the gardening tool attachment is comprised of an elongate reciprocating saw blade formed into a loop shaped gardening tool attachment body having a ground-engaging edge formed of saw blade teeth.

16. The gardening tool attachment of claim 1, wherein the mount comprises a reciprocating power tool mounting tang and the power tool comprises a reciprocating power tool.

17. The gardening tool attachment of claim 16, wherein the reciprocating power tool comprises a reciprocating saw.

18. The gardening tool attachment of claim 1, wherein the gardening tool attachment is formed of a reciprocating saw blade that is three dimensionally formed or shaped into the gardening tool attachment.

19. The gardening tool attachment of claim 1, wherein the gardening tool attachment is formed from a blank for a reciprocating saw blade that is three dimensionally formed or shaped into the gardening tool attachment

20. A gardening tool attachment in combination with a hand-held portable reciprocating power tool comprising:
a battery powered hand held reciprocating power tool having a handle enable hand held operation of the reciprocating power tool by a user and a holder for removably receiving and retaining a reciprocating tool attachment thereto; and
a gardening tool attachment having an elongate body having (a) a mount configured for removable mounting to the holder of the reciprocating tool, (b) a ground-breaking section that engages the ground during reciprocation of the gardening tool attachment by the reciprocating power tool, and (c) at least one guide extending outwardly away from the ground during engagement of the ground by the ground-breaking section.

21. The gardening tool attachment of claim 20, wherein the gardening tool attachment has a pair of guides extending outwardly away from the ground during engagement of the ground by the ground-breaking section that guide movement of the ground-breaking section relative to the ground and wherein the ground-breaking section and pair of spaced apart guides define a generally U-shaped gardening head.

22. The gardening tool attachment of claim 21, wherein each one of the guides have a ground-engaging surface.

23. The gardening tool attachment of claim 21, wherein the ground engaging surface is comprised of a plurality of teeth.
